(19) United States
(12) Patent Application Publication
(10) Pub. No.: US 2002/0171305 A1
(43) Pub. Date: Nov. 21, 2002

(54) Electric machine having an outer rotor

(75) Inventors: Eric Coupart, Angouleme (FR); Pascal Gauthier, Asnieres-Sur-Nouere (FR); Christophe Gilles, Angouleme (FR); Atef Abou Akar, L'Isle D'Espagnac (FR); Jacques Saint-Michel, Angouleme (FR)

Correspondence Address: OLIFF & BERRIDGE, PLC, P.O. BOX 19928, ALEXANDRIA, VA, 22320, US

(73) Assignee: MOTEURS LEROY-SOMER, Angouleme (FR)

(21) Appl. No.: 10/121,577

(22) Filed: Apr. 15, 2002

(30) Foreign Application Priority Data
Apr. 17, 2001 (EP) 01 400981.5
Jul. 5, 2001 (FR) 01 08933

(51) Int. Cl. H02K 21/12

(52) U.S. Cl. 310/156.08

(57) ABSTRACT

The present invention relates a rotary electric machine having

an inner stator having a plurality of teeth each serving as a core of an individual coil, and

an outer rotor comprising:

a non-magnetic casing,

a plurality of permanent magnets disposed inside the non-magnetic casing between pole pieces not having holes for engaging fixing bars

### FIELD OF THE INVENTION

The present invention relates to electric machines, and more particularly, but not exclusively, to synchronous electric motors.

### OBJECTS AND SUMMARY OF THE INVENTION

The invention provides a novel electric motor that is particularly suitable for driving one or more cables or a pneumatic tire directly, i.e. without any gearing.

The novel motor of the invention includes an inner stator and an outer rotor and the rotor comprises a plurality of permanent magnets disposed between pole pieces inside a non-magnetic casing.

The non-magnetic casing is advantageously a one piece casing composed of a single layer of one material.

In a particular embodiment, the stator pole pieces do not have holes for engaging fixing bars.

In a preferred embodiment, the stator has a plurality of teeth each serving as the core of an individual coil.

The stator teeth are advantageously without pole shoes.

Still in a particular embodiment, in a section plane that is perpendicular to the axis of the rotor, each magnet presents two non-parallel faces converging towards the stator.

The rotor inner surface is advantageously circularly cylindrical.

In particular, the invention enables a drive machine to be manufactured that does not have any gearing, e.g. a hoist for a crane, and that is sufficiently quiet to make it possible for the motor to rotate at high speed, when unloaded without contravening standards relating to noise pollution. In the case of a hoist, the productivity of the crane is therefore improved.

The absence of gearing also enables the cost of manufacture of the machine to be reduced considerably.

The pole pieces are advantageously laminated.

The motor of the invention facilitates defluxing due to the fact that the magnetic field generated by the stator coils can penetrate easily into the pole pieces given the disposition of the magnets; in known outer rotors having surface-mounted magnets, the magnetic field generated by the stator meets the magnets which are seen as flux gaps and hinder defluxing.

The number of poles can be relatively high, in particular equal to 32 or 48, for example.

The invention also provides a hoist including a motor as defined above.

The invention also provides a driving wheel including a motor as defined above.

The invention also provides lift or elevator machinery including a motor as defined above.

### BRIEF DESCRIPTION OF THE DRAWING

The invention will be better understood on reading the following detailed description of a non-limiting embodiment example, and on examining the accompanying drawing, in which:

FIG. 1 is a diagrammatic perspective view of both the rotor and the stator, each shown in isolation; and

FIG. 2 is a diagrammatic cross-section of the motor, in a plane that is perpendicular to the axis of the stator.

### MORE DETAILED DESCRIPTION

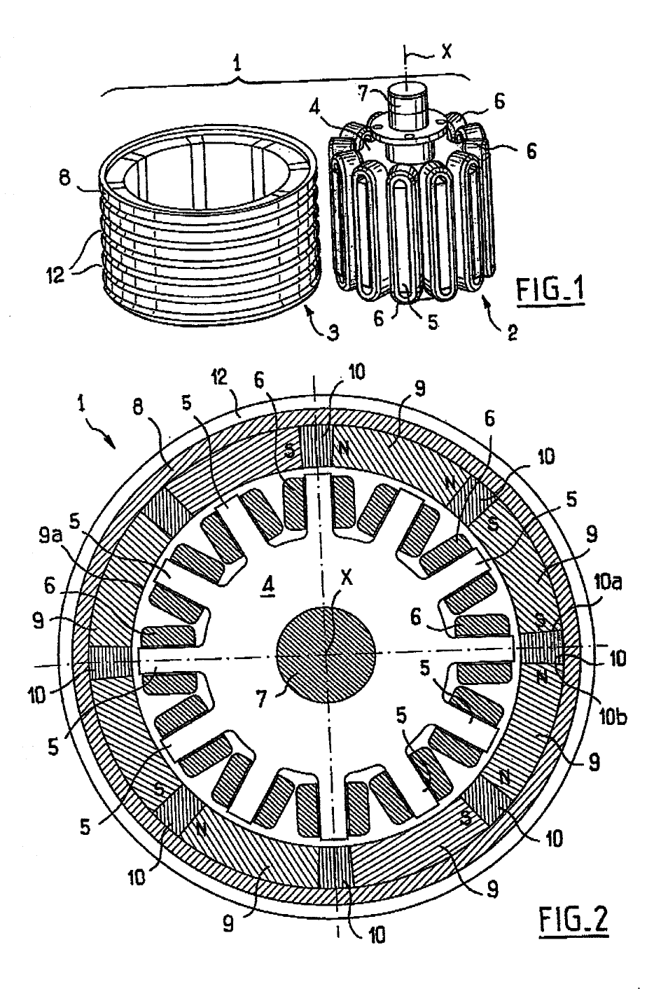

The motor 1 shown in FIGS. 1 and 2 comprises an inner stator 2, and an outer rotor 3 designed to rotate about the axis X and about the stator 2.

The stator 2 can be of any type known per se, but preferably, the stator 2 presents a magnetic circuit 4 including a plurality of teeth 5 each having an individual coil 6 disposed thereon.

The various coils 6 are connected together electrically so as to generate a rotating magnetic field enabling the rotor 3 to be driven.

The coils 6 can be held on the teeth 5 of the stator 2 by means of shims (not shown), such shims being engaged, for example, in notches provided at the ends of the teeth 5.

The stator 2 is secured to a shaft 7 enabling said stator to be fixed on a structure and supporting the bearings of the rotor 3, said bearings not being shown for the sake of keeping the drawing clear. The diameter of the shaft 7 can be relatively large, e.g. greater than 100 mm.

The rotor 3 comprises a non-magnetic casing 8, e.g. made of aluminum or non-magnetic steel, inside which are disposed a plurality of pole pieces 9, and a plurality of permanent magnets 10, eight in number in the example under consideration. The pole pieces 9, like the magnetic circuit 4 of the stator 2, are laminated, i.e. formed by stacking magnetic steel laminations each coated in a layer of varnish so as to reduce the losses caused by induced currents.

The magnets 10 are positioned between the pole pieces 9 so that two adjacent magnets 10 have polarities of the same type turned towards the pole piece 9 extending therebetween. The pole pieces 9 thus concentrate the magnetic flux of the magnets 10. Depending on the length of the machine, each magnet 10 can be formed by assembling a plurality of magnetic bars end to end.

In the embodiment example shown, each magnet 10 has two opposite faces 10a, 10b of opposite polarities, and converging towards the stator.

This disposition makes it possible to ensure that the magnets 10 and the pole pieces 9 are held inside the non-magnetic casing 8 without it being necessary to use fixing means such as bars engaged in holes in the pole pieces 9. The structure of the rotor is thus simplified. The assembly constituted by the pole pieces 9 and the magnets 10 can be force-fitted into the non-magnetic casing 8. The magnets 10 prevent the pole pieces 9 from moving towards the inside by jamming them. The radial extent of the pole pieces 9 is substantially equal to that of the magnets 10, and the pole pieces 9 are in contact with substantially all of the surface of the corresponding faces 10a and 10b of the magnets 10.

In the example shown, the inside radial surface 9a of the pole pieces 9 is circularly cylindrical about the axis X of the stator 2, but it is not beyond the ambit of the present invention for said surface 9a to have a shape that is not circularly cylindrical, e.g. a shape that bulges towards the axis X so as to reduce torque ripple.

The magnetic casing 8 can serve as a wheel rim for a pneumatic tire, in particular when the motor is used in the manufacture of a driving wheel.

As in the example shown, the magnetic casing 8 can also serve to drive a plurality of cables of lift or elevator machinery and can include annular grooves 12 for this purpose.

The magnetic casing 8 can extend over a distance that is greater than the axial dimension of the pole pieces 9 and the magnets 10 in order to include a portion that is offset from the pole pieces 9 and the magnets 10, the above-mentioned annular grooves being present only in the offset portion.

The magnetic casing 8 can also be secured to a pulley serving to drive one or more cables.

In the example described, the motor is designed to be powered by three-phase electricity, it has eight poles, and the stator 2 has twelve teeth 5. It is not beyond the ambit of the present invention for the number of poles to be different, e.g. equal to 32 or 48.

The width of the teeth 5 may or may not be constant, and, where necessary, the coils can present a complementary profile so that they jam on the teeth.

The invention is not limited to a motor and advantageously applies to generators, in particular those having a rotor that rotates at high speed.

The invention thus enables losses in the magnets to be limited, in particular by means of the laminated pole pieces.

1/ A rotary electric machine having
an inner stator having a plurality of teeth each serving as a core of an individual coil, and
an outer rotor comprising:
a non-magnetic casing,
a plurality of permanent magnets disposed inside the non-magnetic casing between pole pieces not having holes for engaging fixing bars.

2/ A machine according to claim 1, wherein, in a section plane that is perpendicular to an axis of said rotor, each magnet presents two non-parallel faces converging towards said stator.

3/ A machine according to claim 1, said machine not having any gearing.

4/ A machine according to claim 1, wherein said pole pieces are laminated.

5/ A machine according to claim 1, wherein said rotor comprises an inner surface which is circularly cylindrical.

6/ A machine according to claim 1, said machine constituting a motor.

7/ A machine according to claim 1, said machine constituting a generator.

8/ A machine according to claim 1, wherein said nonmagnetic casing is configured to serve as a wheel rim for a pneumatic tire.

9/ A machine according to claim 1, wherein said nonmagnetic casing includes annular grooves.
